(19) United States
(12) Patent Application Publication
(10) Pub. No.: US 2021/0168636 A1
(43) Pub. Date: Jun. 3, 2021

(54) METHOD FOR ASSESSING RADIO LINK QUALITY, PARAMETER CONFIGURATION METHOD, APPARATUSES THEREOF AND SYSTEM

(71) Applicant: FUJITSU LIMITED, Kawasaki-shi (JP)

(72) Inventors: Zhe CHEN, Beijing (CN); Lei SONG, Beijing (CN); Meiyi JIA, Beijing (CN); Lei ZHANG, Beijing (CN); Xin WANG, Beijing (CN)

(73) Assignee: FUJITSU LIMITED, Kawasaki-shi (JP)

(21) Appl. No.: 17/170,285

(22) Filed: Feb. 8, 2021

Related U.S. Application Data
(63) Continuation of application No. PCT/CN2018/105770, filed on Sep. 14, 2018.

(51) Int. Cl. H04W 24/08; H04L 5/00; H04W 72/04

(52) U.S. Cl. CPC H04W 24/08; H04W 72/042; H04L 5/0048

(57) ABSTRACT

A method for assessing radio link quality, a parameter configuration method, apparatuses thereof and a system. The method for assessing radio link quality includes: a terminal equipment assesses radio link quality in a first cell according to a reference signal related to downlink data transmission in a first reference signal set. Hence, when a beam failure occurs, the communication system may quickly adjust and recover transmission of downlink signals.

### CROSS-REFERENCE TO RELATED APPLICATION

This application is a continuation application of International Application PCT/CN2018/105770 filed on Sep. 14, 2018 and designated the U.S., the entire contents of which are incorporated herein by reference.

### FIELD

This disclosure relates to the field of communications, and in particular to a method for assessing radio link quality, a parameter configuration method, apparatuses thereof and a system.

### BACKGROUND

A beam failure recovery technique is mainly for high-frequency communication scenarios, in which communication link is susceptible to physical conditions, such as weather, obstacles, changes in directions and angles, etc., resulting in transmission failure in an original beam direction. The beam failure recovery technique is mainly directed to such scenarios, and quickly positions a new reliable beam direction by using measurement results of the power of beams in different directions, thereby completing rapid recovery of the link. The beam failure recovery technique is not only very effective in single-carrier communication scenarios, but also plays an important role in multi-carrier scenarios. At a certain moment, connections on different carriers may have beam failures on only a part of carriers. At this time, the beam failure recovery technique needs to be optimized for this scenario, for example, carriers without beam failure are used to perform parameter measurement and data transmission, thereby improving robustness of a system.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that in a multi-carrier scenario, configurations to which carriers correspond are different. Description shall be given by taking two different scenarios to which FIG. 1 and FIG. 2 correspond as examples. In scenario 1, as shown in FIG. 1, downlink data (data information) of a carrier (serving cell 2) are scheduled by corresponding control signals (control information) on another carrier (serving cell 1), that is, the carrier (serving cell 2) is configured with a resource for receiving downlink data signals, but the carrier (serving cell 2) will not be configured with a resource for receiving downlink control signals. In scenario 2, as shown in FIG. 2, downlink data (data information) of a carrier (serving cell 1) is scheduled by a control signal (control information) on this carrier, that is, the carrier (serving cell 1) is configured with both a resource for receiving downlink control signals and a resource for receiving corresponding downlink data signals. However, when a downlink physical channel to which the serving cell described in scenario 1 or scenario 2 (serving cell 2 in FIG. 1 or serving cell 1 in FIG. 2) corresponds changes sharply, beam failure will occur, resulting in that downlink signals unable to be received correctly.

In order to solve at least one of the above problems or other similar problems, embodiments of this disclosure provide a method for assessing radio link quality, a parameter configuration method, apparatuses thereof and a system, in which when a beam failure occurs, the communication system may quickly adjust and recover transmission of downlink signals.

According to a first aspect of the embodiments of this disclosure, there is provided a method for assessing radio link quality, the method including:

assessing radio link quality in a first cell by a terminal equipment according to a reference signal related to downlink data transmission in a first reference signal set.

According to a second aspect of the embodiments of this disclosure, there is provided a parameter configuration method, the method including:

configuring a first reference signal set for a terminal equipment by a network device, the terminal equipment assessing radio link quality in a first cell according to a reference signal related to downlink data transmission in the first reference signal set, the first cell being a cell not configured with a downlink control channel, or a cell scheduled by control signals of other cells than the first cell.

According to a third aspect of the embodiments of this disclosure, there is provided an apparatus for assessing radio link quality, configured in a terminal equipment, the apparatus including:

a first assessing unit configured to assess radio link quality in a first cell according to a reference signal related to downlink data transmission in a first reference signal set.

According to a fourth aspect of the embodiments of this disclosure, there is provided a parameter configuration apparatus, configured in a network device, the apparatus including:

a first configuring unit configured to configure a first reference signal set for a terminal equipment, the terminal equipment assessing radio link quality in a first cell according to a reference signal related to downlink data transmission in the first reference signal set, the first cell being a cell not configured with a downlink control channel, or a cell scheduled by control signals of other cells than the first cell.

According to a fifth aspect of the embodiments of this disclosure, there is provided a terminal equipment, wherein the terminal equipment including the apparatus as described in the third aspect.

According to a sixth aspect of the embodiments of this disclosure, there is provided a network device, wherein the network device including the apparatus as described in the fourth aspect.

According to a seventh aspect of the embodiments of this disclosure, there is provided a communication system, including the terminal equipment as described in the fifth aspect and the network device as described in the sixth aspect.

According to another aspect of the embodiments of this disclosure, there is provided a computer readable program, which, when executed in a terminal equipment, will cause a computer to carry out the method described in the first aspect in the terminal equipment.

According to a further aspect of the embodiments of this disclosure, there is provided a storage medium, including a computer readable program, which will cause a computer to carry out the method described in the first aspect in a terminal equipment.

According to yet another aspect of the embodiments of this disclosure, there is provided a computer readable program, which, when executed in a network device, will cause a computer to carry out the method described in the second aspect in the network device.

According to a still another aspect of the embodiments of this disclosure, there is provided a storage medium, including a computer readable program, which will cause a computer to carry out the method described in the second aspect in a network device.

An advantage of the embodiments of this disclosure exists in that the terminal equipment assesses radio link quality in a first cell according to a reference signal related to downlink data transmission in a first reference signal set. Hence, when a beam failure occurs, the communication system may quickly adjust and recover transmission of downlink signals.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is a schematic diagram of beam failure detection of a serving cell receiving downlink data information only;

FIG. 2 is a schematic diagram of beam failure detection of a serving cell receiving downlink control information;

FIG. 3 is a schematic diagram of a communication system of an embodiment of this disclosure;

FIG. 4 is a schematic diagram of the method for assessing radio link quality of Embodiment 1;

FIG. 5 is a schematic diagram of the method for assessing radio link quality of Embodiment 2;

FIG. 6 is a schematic diagram of the parameter configuration method of Embodiment 3;

FIG. 7 is a schematic diagram of the apparatus for assessing radio link quality of Embodiment 4;

FIG. 8 is a schematic diagram of the apparatus for assessing radio link quality of Embodiment 5;

FIG. 9 is a schematic diagram of the apparatus for assessing radio link quality of Embodiment 6;

FIG. 10 is a schematic diagram of the parameter configuration apparatus of Embodiment 7;

FIG. 11 is a schematic diagram of the terminal equipment of Embodiment 8; and

FIG. 12 is a schematic diagram of the network device of Embodiment 9.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to an equipment in a communication system that accesses a terminal equipment to the communication network and provides services for the terminal equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB). Furthermore, it may include a remote radio head (RRH), a remote radio unit (RRU), a relay, or a low-power node (such as a femto, and a pico). The term “base station” may include some or all of its functions, and each base station may provide communication coverage for a specific geographical area. And a term “cell” may refer to a base station and/or its coverage area, which may be expressed as a serving cell, and may be a macro cell or a pico cell, depending on a context of the term.

In the embodiments of this disclosure, the term “user equipment (UE)” refers to, for example, equipment accessing to a communication network and receiving network services via a network device, and may also be referred to as “terminal equipment (TE)”. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Scenarios in the embodiments of this disclosure shall be described below by way of examples; however, this disclosure is not limited thereto.

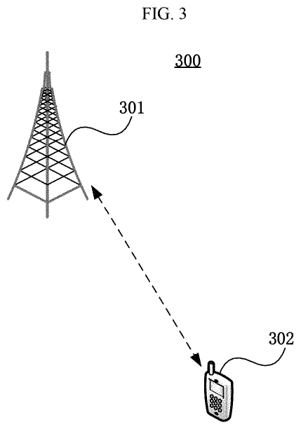

FIG. 3 is a schematic diagram of a communication system of an embodiment of this disclosure, in which a case where a terminal equipment and a network device are taken as examples is schematically shown. As shown in FIG. 3, a communication system 300 may include a network device 301 and terminal equipments 302. For the sake of simplicity, an example having only one terminal equipment is schematically given in FIG. 3. And the network device 301 is, for example, a network device gNB in a NR system.

In the embodiment of this disclosure, existing traffics or traffics that may be implemented in the future may be performed between the network device 301 and the terminal equipment 302. For example, such traffics may include but not limited to enhanced mobile broadband (eMBB), massive machine type communication (mMTC), and ultra-reliable and low-latency communication (URLLC), etc.

The terminal equipment 302 may transmit data to the network device 301, for example, in a grant-free transmission mode. The network device 301 may receive data transmitted by one or more terminal equipments 302, and feed back information (such as acknowledgement ACK/non-acknowledgement NACK) to the terminal equipment 302, and the terminal equipment 302 may acknowledge terminating a transmission process according to the feedback information, or may further perform new data transmission, or may perform data retransmission.

Implementations of the embodiments of this disclosure shall be described below with reference to the accompanying drawings. These implementations are illustrative only, and are not intended to limit this disclosure.

### Embodiment 1

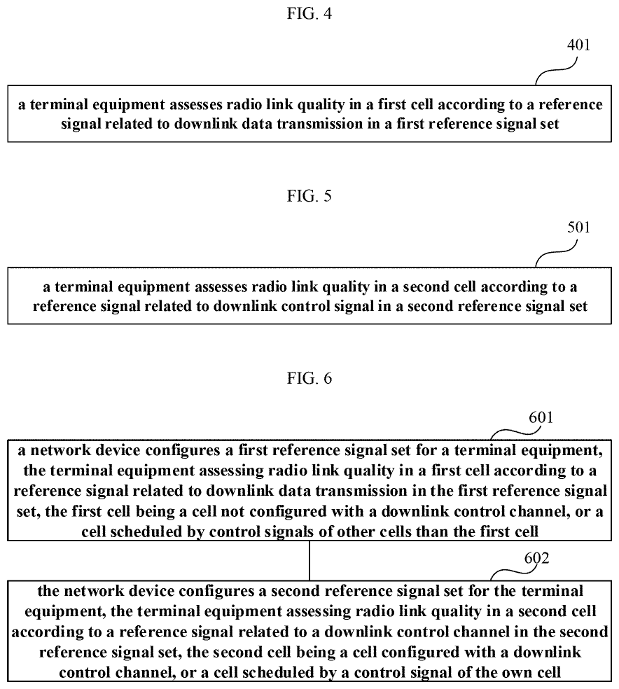

The embodiment of this disclosure provides a method for assessing radio link quality, applicable to a terminal equipment. FIG. 4 is a schematic diagram of the method for assessing radio link quality of this embodiment. Referring to FIG. 4, the method includes:

step 401: a terminal equipment assesses radio link quality in a first cell according to a reference signal related to downlink data transmission in a first reference signal set.

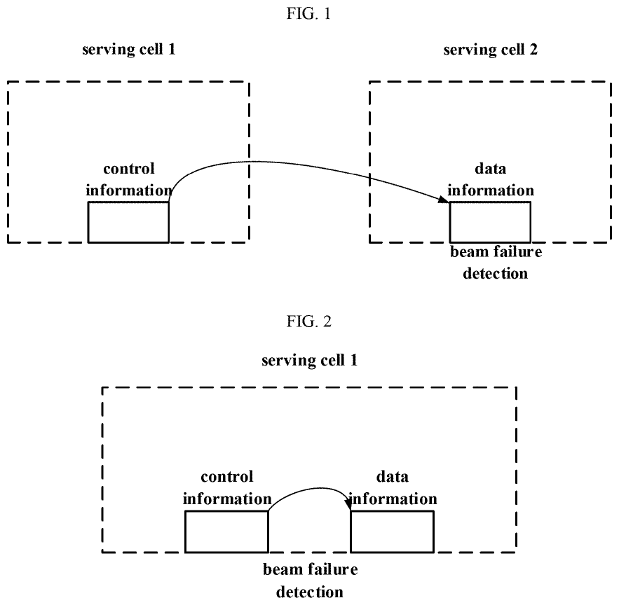

In this embodiment, the first cell is a cell not configured with a downlink control channel, or a cell scheduled by control signals of other cells than the first cell. That is, the first cell may be the serving cell 2 in the scenario of FIG. 1. In this scenario, the terminal equipment may assess the radio link quality in the first cell according to a reference signal in the first reference signal set related to the downlink data transmission. Therefore, when a beam failure occurs, the terminal equipment may still assess the radio link quality, and the communication system may quickly adjust and recover the transmission of the downlink signal.

In this embodiment, the first reference signal set shall be described below.

In one implementation, the above first reference signal set may be a set (q0) of reference signals used for beam failure detection provided by higher layer parameters (such as failureDetectionResources). In this embodiment, the reference signal set is, for example, a set of indices of reference signals, which are used to indicate the reference signals; however, this embodiment is not limited thereto, and the reference signal set may also be a set in another form used for indicating information on reference signals.

In another implementation, the above first reference signal set may also be a subset of the set q0. For example, the above first reference signal set may be a set (q1) of reference signals in the above set q0 quasi co-located (QCL) with reference signals related to downlink data transmission, or a set (q2) of reference signals in the set q0 having indices identical to those of reference signals related to downlink data transmission.

In this embodiment, if the terminal equipment is provided with the higher layer parameters indicating the reference signal used for beam failure detection, such as failureDetectionResources, the terminal equipment may take the above-described q0 or the subset q1 or q2 of q0 as the above first reference signal set, and assess the radio link quality by using a reference signal in q0 or q1 or q2 related to the downlink data transmission.

In this embodiment, if the terminal equipment is not provided with the higher layer parameters indicating the reference signal used for beam failure detection, the terminal equipment may directly take a set (q3) of reference signals quasi co-located (QCL) with the reference signals related to the downlink data transmission as the first reference signal set, or may take a set (q4) of reference signals having indices identical to those of reference signals related to downlink data transmission as the first reference signal set, and assess the radio link quality by using a reference signal in q3 or q4 related to the downlink data transmission.

In this embodiment, the reference signals related to the downlink data transmission shall be described below.

In one implementation, the reference signals related to the downlink data transmission may be reference signals to which TCI states in a transmission configuration indication (TCI) state list configured by a higher layer parameter (such as a parameter provided by RRC signaling) correspond.

In this implementation, the network device configures the TCI state list for the terminal equipment via a higher layer parameter, such as tci-StatesToAddModList, or tci-StatesToReleaseList. The TCI state list includes a series of TCI states (such as TUI-Stale), the TCI states indicating a QCL relationship between the downlink reference signals (DL RSs in one RS set) and DMRS ports of downlink data channels (PDSCH DMRS ports). The terminal equipment may assess the radio link quality in the above first cell by using a reference signal to which at least one TCI state in the TCI state list corresponds.

In another implementation, the reference signals related to the downlink data transmission may also be reference signals to which TCI states indicated by the higher layer signaling correspond.

In this implementation, the network device may also indicate one or more TCI states (such as TCI-State) in the TCI state list (such as ci-StatesToAddModLst, or tci-StatesToReleaseList) configured by the higher layer parameter of the above first cell (the higher layer parameter may be for an activated BWP, or another specific BWP) via higher layer signaling (such as an MAC CE activation command, i.e. MAC CE signaling used for activating/deactivating TCI states) acting on the above first cell. And the terminal equipment may assess the radio link quality in the above first cell by using reference signals to which the one or more TCI states correspond.

In this implementation, the TCI states indicated by the higher layer signaling refers to TCI states mapped onto codepoints of a transmission configuration indication field of downlink control information (DCI) by the higher layer signaling. That is, the higher layer signaling may indicate the one or more TCI states in the following manner, that is, the higher layer signaling map all or part of TCI states in the above TCI state list onto the codepoints of the transmission configuration indication field of the DCI. For example, the number of the codepoints may be 8, and a corresponding transmission configuration indication field of the DCI is of 3 bits. The TCI states mapped onto the codepoints of the transmission configuration indication field of the DCI are the TCI states indicated by the above higher layer signaling.

In a further implementation, if the terminal equipment receives the higher layer signaling, the reference signal related to the downlink data transmission may also be a reference signal to which a TCI state indicated by the higher layer signaling corresponds.

In this implementation, if the terminal equipment receives the higher layer signaling from the network device, the terminal equipment may assess the radio link quality in the above first cell by using the reference signals to which the TCI state indicated by the higher layer signaling corresponds, that is, assessing the radio link quality in the above second manner.

In yet another implementation, if the terminal equipment receives the higher layer signaling, the reference signal related to the downlink data transmission may also be the reference signal to which a TCI state indicated by the higher layer signaling corresponds; and if the terminal equipment does not receive the higher layer signaling, the reference signal related to the downlink data transmission may be the reference signal to which the TCI state in the TCI state list configured by the higher layer parameter corresponds.

In this implementation, if the terminal equipment receives the higher layer signaling from the network device, the terminal equipment may assess the radio link quality in the above first cell by using the reference signals to which the TCI state indicated by the higher layer signaling corresponds, that is, assessing the radio link quality in the above second manner; and if the terminal equipment does not receive the higher layer signaling from the network device, the terminal equipment may assess the radio link quality in the above first cell by using the reference signal to which the at least one TCI state in the TCI state list corresponds, that is, assessing the radio link quality in the above first manner.

In this embodiment, the reference signal may be a periodic channel state information reference signal (CSI-RS), may also be a synchronization signal/physical broadcast channel (SS/PBCH) block. And the reference signal may also be a semi-persistent or aperiodic channel state information reference signal (CSI-RS); however, this embodiment is not limited thereto.

In this embodiment, with regard to assessing the radio link quality, the terminal equipment may assess the radio link quality according to comparison of measurement results of the reference signals in the above first reference signal set related to the downlink data transmission with a threshold.

In one implementation, the threshold may be a threshold related to a first parameter and a second parameter; here, the first parameter is a block error rate (BLER) for generating out-of-synchronization (OOS) indication, and the second parameter is reference signal received power (RSRP) of SSs/PBCHs.

In this implementation, the radio link quality may be assessed according to the comparison between the measurement results of the above reference signals and the threshold, and a particular method for assessing is not limited in his embodiment. Furthermore, in this implementation, with the threshold, the UE may select an SS block and a corresponding PRACH resource for pathloss estimation and transmission (retransmission) based on synchronization signal blocks (SS blocks) satisfying the threshold.

In another implementation, the threshold may be a threshold used for being compared with a measurement result of RSRP of L1 layer of the reference signals.

In this implementation, the threshold may be configured by the network device via higher layer signaling; however, this embodiment is not limited thereto.

In this implementation, the measurement result of RSRP of L1 layer of the reference signal may be a measurement result of RSRP of L1 layer of the SSs/PBCHs, may also be a measurement result of RSRP of L1 layer of CSI-RS resources scaled by a higher layer parameter; however, this embodiment is not limited thereto.

In this embodiment, the above higher layer parameter may be a parameter indicating a power difference between a non-zero power CSI-RS (NZP CSI-RS) resource element and a synchronization signal resource element, such as powerControlOffsetSS; however, this embodiment is not limited thereto.

With the method of this embodiment, in a cell that is not configured with a downlink control channel (i.e. the first cell), or in a cell that is scheduled by a control signal of another cell (i.e. the first cell), the terminal equipment may assess the radio link quality in the first cell according to the reference signal related to the downlink data transmission in the first reference signal set. Hence, when a beam failure occurs, the terminal equipment may still assess the radio link quality, and the communication system may quickly adjust and recover transmission of downlink signals.

### Embodiment 2

The embodiment of this disclosure provides a method for assessing radio link quality, applicable to a terminal equipment. FIG. 5 is a schematic diagram of the method for assessing radio link quality of this embodiment. Referring to FIG. 5, the method includes: step 501: a terminal equipment assesses radio link quality in a second cell according to a reference signal related to downlink control channel in a second reference signal set.

In this embodiment, the second cell is a cell configured with a downlink control channel, or a cell scheduled by a control signal of the own cell. That is, the second cell may be the serving cell 1 in the scenario of FIG. 2. In this scenario, the terminal equipment may assess the radio link quality in the second cell according to the reference signal in the second reference signal set related to the downlink control channel. Therefore, when a beam failure occurs, the terminal equipment may still assess the radio link quality, and the communication system may quickly adjust and recover the transmission of the downlink signal.

In this embodiment, the second reference signal set shall be described below.

In one implementation, the second reference signal set may be a set (q0) of reference signals used for beam failure detection provided by higher layer parameters (such as failureDetectionResources). In this embodiment, the reference signal set is, for example, a set of indices of reference signals, which are used to indicate the reference signals; however, this embodiment is not limited thereto, and the reference signal set may also be a set in another form used for indicating information on reference signals.

In another implementation, the second reference signal set may also be a subset of the set q0. For example, the above second reference signal set may be a set q1′ of reference signals in the above set q0 quasi co-located (QCL) with reference signals related to downlink control channel, or a set q2′ of reference signals in the above set q0 having indices identical to those of reference signals related to downlink control channel.

In this embodiment, if the terminal equipment is provided with the higher layer parameters indicating the reference signal used for beam failure detection, such as failureDetectionResources, the terminal equipment may take the above q0 or the subset q1′ or q2′ of q0 as the above second reference signal set, and assess the radio link quality by using the reference signal in q0 or q1′ or q2′ related to the downlink control channel.

In this embodiment, if the terminal equipment is not provided with the higher layer parameters indicating the reference signal used for beam failure detection, the terminal equipment may directly take a set (q3′) of reference signals quasi co-located (QCL) with the reference signals related to the downlink control channel as the second reference signal set, or may take a set (q4′) of reference signals having indices identical to those of reference signals related to downlink control channel as the second reference signal set, and assess the radio link quality by using the reference signal in q3′ or q4′ related to the downlink control channel.

In this embodiment, the reference signals related to the downlink control channel shall be described below.

In one implementation, the reference signals related to the downlink control channel may be DM-RSs used by the terminal equipment in monitoring control channels.

In this implementation, the terminal equipment may assess the radio link quality in the above second cell by using the above DM-RSs.

In another implementation, the reference signals related to the downlink control channel may be reference signals indicated by TCI states to which CORESETs used by the terminal equipment in monitoring control channels correspond.

In this implementation, the terminal equipment may assess the radio link quality in the above second cell by using the reference signals indicated by the TCI states to which the CORESETs used by the terminal equipment in monitoring control channels correspond.

In this embodiment, the reference signal may be a periodic channel state information reference signal (CSI-RS), may also be a synchronization signal/physical broadcast channel (SS/PBCH) block; however, this embodiment is not limited thereto.

In this embodiment, with regard to assessing the radio link quality, the terminal equipment may assess the radio link quality according to comparison of measurement results of the reference signals in the above second reference signal set related to the downlink control channel with a threshold.

In one implementation, the threshold may be a threshold related to a first parameter and a second parameter; here, the first parameter is a block error rate (BLER) for generating out-of-synchronization (OOS) indication, and the second parameter is reference signal received power (RSRP) of SSs/PBCHs.

In this implementation, the radio link quality may be assessed according to the comparison between the measurement results of the above reference signals and the threshold, and a particular method for assessing is not limited in his embodiment. Furthermore, in this implementation, with the threshold, the UE may select an SS block and a corresponding PRACH resource for pathloss estimation and transmission (retransmission) based on synchronization signal blocks (SS blocks) satisfying the threshold.

In another implementation, the threshold may be a threshold used for being compared with a measurement result of RSRP of L1 layer of the reference signals.

In this implementation, the threshold may be configured by the network device via higher layer signaling; however, this embodiment is not limited thereto.

In this implementation, the measurement result of RSRP of L1 layer of the reference signal may be a measurement result of RSRP of L1 layer of the SSs/PBCHs, or a measurement result of RSRP of L1 layer of CSI-RS resources scaled by a higher layer parameter; however, this embodiment is not limited thereto.

In this embodiment, the above higher layer parameter may be a parameter indicating a power difference between a non-zero power CSI-RS (NZP CSI-RS) resource element and a synchronization signal resource element, such as powerConrolOffsetSS; however, this embodiment is not limited thereto.

With the method of this embodiment, in a cell that is configured with a downlink control channel (i.e. the second cell), or in a cell that is scheduled by a control signal of the own cell (i.e. the second cell), the terminal equipment may assess the radio link quality in the second cell according to the reference signal related to the downlink control channel in the second reference signal set. Hence, when a beam failure occurs, the terminal equipment may still assess the radio link quality, and the communication system may quickly adjust and recover transmission of downlink signals.

In Embodiment 1 and Embodiment 2, assessing the radio link quality by the terminal equipment in the first cell and the second cell are described respectively. The above two embodiments may be used in a combined manner, or may be used separately, which is not limited in this disclosure.

### Embodiment 3

The embodiment of this disclosure provides a parameter configuration method. This method is applicable to a network device, and is processing at a network device side corresponding to the methods in Embodiment 1 and Embodiment 2, contents in this method identical to those in Embodiment 1 and Embodiment 2 being not going to be repeated herein any further. FIG. 6 is a schematic diagram of the parameter configuration method of this embodiment. As shown in FIG. 6, the method includes:

step 601: a network device configures a first reference signal set for a terminal equipment, the terminal equipment assessing radio link quality in a first cell according to a reference signal related to downlink data transmission in the first reference signal set, the first cell being a cell not configured with a downlink control channel, or a cell scheduled by control signals of other cells than the first cell.

In this embodiment, step 601 corresponds to the method in Embodiment 1, in which the above first reference signal set is configured by the network device for the terminal equipment, and the terminal equipment may assess the radio link quality in the first cell according to the method in Embodiment 1, thereby solving a problem that the terminal equipment is unable to assess radio link quality in a case where beam failure occurs in the above first cell.

In this embodiment, the network device may further transmit corresponding reference signals to the terminal equipment according to configuration information of the first reference signal set. Hence, the terminal equipment may assess the radio link quality in the method in Embodiment 1 by using corresponding reference signals.

In this embodiment, as shown in FIG. 6, the method may further include:

step 602: the network device configures a second reference signal set for the terminal equipment, the terminal equipment assessing radio link quality in a second cell according to a reference signal related to a downlink control channel in the second reference signal set, the second cell being a cell configured with a downlink control channel, or a cell scheduled by a control signal of the own cell.

In this embodiment, step 602 corresponds to the method in Embodiment 2, in which the above second reference signal set is configured by the network device for the terminal equipment, and the terminal equipment may assess the radio link quality in the second cell according to the method in Embodiment 2, thereby solving a problem that the terminal equipment is unable to assess radio link quality in a case where beam failure occurs in the above second cell.

In this embodiment, the network device may further transmit corresponding reference signals to the terminal equipment according to configuration information of the second reference signal set. Hence, the terminal equipment may assess the radio link quality in the method in Embodiment 2 by using corresponding reference signals.

In this embodiment, the above reference signals are reference signals for the purpose of beam failure detection. The reference signals are described in detail in Embodiment 1 and Embodiment 2, the contents of which being incorporated herein, and being not going to be described herein any further.

In FIG. 6, steps 601 and 602 are listed simultaneously; however, in implementation, steps 601 and 602 may be executed separately, or may be executed together, which are not limited in this embodiment. And an order of execution of steps 601 and 602 is not limited in this embodiment, and they be executed in a changed order, or may be executed simultaneously.

### Embodiment 4

This embodiment provides an apparatus for assessing radio link quality, configured in a terminal equipment. As principles of the apparatus for solving problems are similar to that of the method in Embodiment 1, reference may be made to the implementation of the method in Embodiment 1 for implementation of this apparatus, with identical contents being not going to be described herein any further.

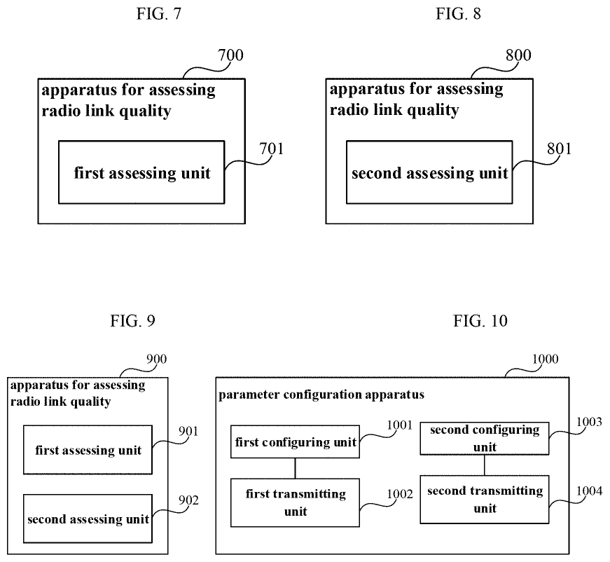

FIG. 7 is a schematic diagram of the apparatus for assessing radio link quality of this embodiment. Referring to FIG. 7, an apparatus 700 for assessing radio link quality includes: a first assessing unit 701 configured to assess radio link quality in a first cell according to a reference signal related to downlink data transmission in a first reference signal set.

In this embodiment, the first cell is a cell not configured with a downlink control channel, or a cell scheduled by control signals of other cells than the first cell.

In one implementation, the first reference signal set is a set (q0) of reference signals provided by a higher layer parameter and for the purpose of beam failure detection, or a set (q1) of reference signals quasi co-located with reference signals associated with downlink data transmission in a set (q0) of reference signals provided by a higher layer parameter and for the purpose of beam failure detection, or a set (q2) of reference signals with the same indices as reference signals associated with downlink data transmission in a set (q0) of reference signals provided by a higher layer parameter and for the purpose of beam failure detection.

In another implementation, the first reference signal set is a set (q3) of reference signals quasi co-located with reference signals associated with downlink data transmission, or a set (q4) of reference signals with the same indices as reference signals associated with downlink data transmission.

In one implementation, if the terminal equipment is provided with the higher layer parameters indicating the reference signal used for beam failure detection, the above-described q0 or q1 or q2 may be taken as the above first reference signal set, and the radio link quality may be assessed in the first cell by using the reference signal in the set (q0 or q1 or q2) related to the downlink data transmission. And if the terminal equipment is not provided with the higher layer parameters indicating the reference signal used for beam failure detection, the above-described q3 or q4 may be taken as the first reference signal set, and the radio link quality may be assessed in the first cell by using the reference signal in the set (q3 or q4) related to the downlink data transmission.

In this embodiment, the reference signals associated with downlink data transmission may be: reference signals to which TCI states in a TCI state list configured by a higher layer parameter correspond, or reference signals to which TCI states indicated by higher layer signaling correspond; or if the terminal equipment receives the higher layer signaling, the reference signals associated with downlink data transmission are: reference signals to which TCI states indicated by the higher layer signaling correspond, otherwise, the reference signals associated with downlink data transmission are: reference signals to which TCI states in a TCI state list configured by the higher layer parameter correspond; or, if the terminal equipment receives the higher layer signaling, the reference signals associated with downlink data transmission are: reference signals to which TCI states indicated by the higher layer signaling correspond.

In this embodiment, the reference signals may be periodic channel state information reference signals (CSI-RSs) or synchronization signals/physical broadcast channels (SSs/PBCHs). And the reference signal may also be a semi-persistent or aperiodic channel state information reference signal (CSI-RS).

In this embodiment, the first assessing unit 701 may assess the radio link quality according to comparison of measurement results for a reference signal with a threshold.

In one implementation, the threshold may be a threshold related to a first parameter and a second parameter; wherein the first parameter is a block error rate (BLER) for generating out-of-synchronization indication, and the second parameter is reference signal received power (RSRP) of SSs/PBCHs.

In another implementation, the threshold may be a threshold used for being compared with a measurement result of RSRP of L1 layer of the reference signals. In this implementation, the measurement result of RSRP of L1 layer of the reference signals may be: a measurement result of RSRP of L1 layer of the SSs/PBCHs, or may also be a measurement result of RSRP of L1 layer of CSI-RSs scaled by a higher layer parameter.

With the apparatus of this embodiment, the terminal equipment may assess the radio link quality in the first cell according to the reference signal related to the downlink data transmission in the first reference signal set. Hence, when a beam failure occurs, the terminal equipment may still assess the radio link quality, and the communication system may quickly adjust and recover transmission of downlink signals.

### Embodiment 5

The embodiment of this disclosure provides an apparatus for assessing radio link quality, configured in a terminal equipment. As principles of the apparatus for solving problems are similar to that of the method in Embodiment 2, reference may be made to the implementation of the method in Embodiment 2 for implementation of this apparatus, with identical contents being not going to be described herein any further.

FIG. 8 is a schematic diagram of the apparatus for assessing radio link quality of this embodiment. Referring to FIG. 8, an apparatus 800 for assessing radio link quality includes: a second assessing unit 801 configured to assess radio link quality in a second cell according to a reference signal related to a downlink control channel in a second reference signal set.

In this embodiment, the second cell is a cell configured with a downlink control channel, or a cell scheduled by a control signal of the own cell.

In one implementation, the second reference signal set is a set (q0) of reference signals provided by a higher layer parameter and for the purpose of beam failure detection, or may be a set (q1′) of reference signals quasi co-located (QCL) with reference signals related to downlink control channel in the set (q0) of reference signals provided by a higher layer parameter and for the purpose of beam failure detection, or a set (q2′) of reference signals having indices identical to those of reference signals related to downlink control channel in the set (q0) of reference signals provided by a higher layer parameter and for the purpose of beam failure detection.

In another implementation, the second reference signal set is a set (q3′) of reference signals quasi co-located (QCL) with the reference signals related to the downlink control channel, or may be a set (q4′) of reference signals having indices identical to those of reference signals related to downlink control channel.

In one implementation, if the terminal equipment is provided with the higher layer parameters indicating the reference signal used for beam failure detection, the above q0 or q1′ or q2′ may be taken as the above second reference signal set, and the radio link quality may be assessed in the above second cell by using the reference signal in the set (q0 or q1′ or q2′) related to the downlink control channel. And if the terminal equipment is not provided with the higher layer parameters indicating the reference signal used for beam failure detection, the above q3′ or q4′ may be taken as the second reference signal set, and the radio link quality may be assessed in the above second cell according to the reference signal in the set (q3′ or q4′) related to the downlink control channel.

In this embodiment, the reference signals associated with downlink control channel may be DM-RSs used by the terminal equipment in monitoring a control channel, or reference signals indicated by TCI states to which CORESET used by the terminal equipment in monitoring a control channel corresponds.

In this embodiment, the reference signal may be a periodic channel state information reference signal (CSI-RS), or a synchronization signal/physical broadcast channel (SS/PBCH). And the reference signal may also be a semi-persistent or aperiodic channel state information reference signal (CSI-RS).

In this embodiment, the second assessing unit 801 may assess the radio link quality according to the comparison between the measurement results of the reference signals and a threshold In one implementation, the threshold may be a threshold related to a first parameter and a second parameter; wherein the first parameter is a block error rate (BLER) for generating out-of-synchronization indication, and the second parameter is reference signal received power (RSRP) of SSs/PBCHs.

In another implementation, the threshold is a threshold used for being compared with a measurement result of RSRP of L1 layer of the reference signals. In this implementation, the measurement result of RSRP of L1 layer of the reference signals may be: a measurement result of RSRP of L1 layer of the SSs/PBCHs, or may also be a measurement result of RSRP of L1 layer of CSI-RSs scaled by a higher layer parameter.

With the apparatus of this embodiment, the terminal equipment may assess the radio link quality in the second cell according to the reference signal related to the downlink control channel in the second reference signal set. Hence, when a beam failure occurs, the terminal equipment may still assess the radio link quality, and the communication system may quickly adjust and recover transmission of downlink signals.

### Embodiment 6

The embodiment of this disclosure provides an apparatus for assessing radio link quality, configured in a terminal equipment.

FIG. 9 is a schematic diagram of the apparatus for assessing radio link quality of this embodiment. Referring to FIG. 9, an apparatus 900 for assessing radio link quality includes: a first assessing unit 901 and a second assessing unit 902. Implementation of the first assessing unit 901 is identical to the implementation of the first assessing unit 701 in Embodiment 4, and implementation of the second assessing unit 902 is identical to the implementation of the second assessing unit 801 in Embodiment 5, contents of Embodiment 4 and Embodiment 5 being incorporated herein, and being not going to be described herein any further.

With the apparatus of this embodiment, the terminal equipment may assess the radio link quality in the first cell according to the reference signal related to the downlink data transmission in the first reference signal set, and assess the radio link quality in the second cell according to the reference signal related to the downlink control channel in the second reference signal set. Hence, when a beam failure occurs, the terminal equipment may still assess the radio link quality, and the communication system may quickly adjust and recover transmission of downlink signals.

### Embodiment 7

The embodiment of this disclosure provides a parameter configuration apparatus, configured in a network device. As principles of the apparatus for solving problems are similar to that of the method in Embodiment 3, reference may be made to the implementation of the method in Embodiment 3 for implementation of this apparatus, with identical contents being not going to be described herein any further.

FIG. 10 is a schematic diagram of the parameter configuration apparatus of this embodiment. As shown in FIG. 10, a parameter configuration apparatus 1000 includes:

a first configuring unit 1001 configured to configure a first reference signal set for a terminal equipment, the terminal equipment assessing radio link quality in a first cell according to a reference signal related to downlink data transmission in the first reference signal set, the first cell being a cell not configured with a downlink control channel, or a cell scheduled by control signals of other cells than the first cell.

In this embodiment, as shown in FIG. 10, the parameter configuration apparatus 1000 may further include:

a first transmitting unit 1002 configured to transmit corresponding reference signals to the terminal equipment according to configuration information of the first reference signal set.

In this embodiment, as shown in FIG. 10, the parameter configuration apparatus 1000 may further include:

a second configuring unit 1003 configured to configure a second reference signal set for the terminal equipment, the terminal equipment assessing radio link quality in a second cell according to a reference signal related to a downlink control channel in the second reference signal set, the second cell being a cell configured with a downlink control channel, or a cell scheduled by a control signal of the own cell.

In this embodiment, as shown in FIG. 10, the parameter configuration apparatus 1000 may further include:

a second transmitting unit 1004 configured to transmit corresponding reference signals to the terminal equipment according to configuration information of the second reference signal set.

In this embodiment, the reference signals are reference signals for the purpose of beam failure detection.

In this embodiment, the first configuring unit 1001 and the first transmitting unit 1002 may be used separately, or may be used together with the second configuring unit 1003 and the second transmitting unit 1004. Likewise, the second configuring unit 1003 and the second transmitting unit 1004 may be used separately, or may be used together with the first configuring unit 1001 and the first transmitting unit 1002.

With the apparatus of this embodiment, the terminal equipment may assess the radio link quality in the first cell according to the reference signal related to the downlink data transmission in the first reference signal set, and assess the radio link quality in the second cell according to the reference signal related to the downlink control channel in the second reference signal set. Hence, when a beam failure occurs, the terminal equipment may still assess the radio link quality, and the communication system may quickly adjust and recover transmission of downlink signals.

### Embodiment 8

The embodiment of this disclosure provides a terminal equipment, including the apparatus described in Embodiment 4 or 5 or 6.

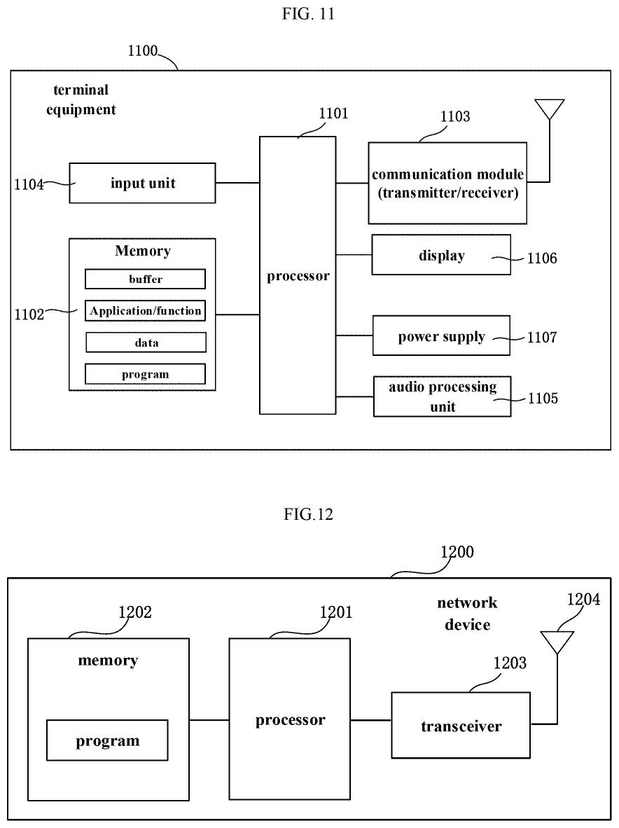

FIG. 11 is a schematic diagram of the terminal equipment of the embodiment of this disclosure. As shown in FIG. 11, a terminal equipment 1100 may include a central processing unit 1101 and a memory 1102, the memory 1102 being coupled to the central processing unit 1101. It should be noted that this figure is illustrative only, and other types of structures may also be used, so as to supplement or replace this structure and achieve a telecommunications function or other functions.

In one implementation, the functions of the apparatus described in Embodiment 4 or 5 or 6 may be integrated into the central processing unit 1101, and the central processing unit 1101 executes functions of the apparatus described in Embodiment 4 or 5 or 6. The functions of the apparatus described in Embodiment 4 or 5 or 6 are incorporated herein, and shall not be described herein any further.

In another implementation, the apparatus described in Embodiment 4 or 5 or 6 and the central processing unit 1101 may be configured separately; for example, the apparatus described in Embodiment 4 or 5 or 6 may be configured as a chip connected to the central processing unit 1101, and the functions of the apparatus described in Embodiment 4 or 5 or 6 are executed under control of the central processing unit 1101.

As shown in FIG. 11, the terminal equipment 1100 may further include a communication module 1103, an input unit 1104, an audio processing unit 1105, a display 1106, and a power supply 1107, etc. It should be noted that the terminal equipment 1100 does not necessarily include all the parts shown in FIG. 11. Furthermore, the terminal equipment 1100 may include parts not shown in FIG. 11, and the related art may be referred to.

As shown in FIG. 11, the central processing unit 1101 is sometimes referred to as a controller or an operational control, which may include a microprocessor or other processor devices and/or logic devices. The central processing unit 1101 receives input and controls operations of components of the terminal equipment 1100.

The memory 1102 may be, for example, one or more of a buffer memory, a flash memory, a hard drive, a mobile medium, a volatile memory, a nonvolatile memory, or other suitable devices, which may store various data, etc., and furthermore, store programs executing related information. And the central processing unit 1101 may execute programs stored in the memory 1102, so as to realize information storage or processing, etc. Functions of other parts are similar to those of the related art, which shall not be described herein any further. The parts of the terminal equipment 1100 may be realized by specific hardware, firmware, software, or any combination thereof, without departing from the scope of this disclosure.

With the terminal equipment of this embodiment, the terminal equipment may assess the radio link quality in the first cell according to the reference signal related to the downlink data transmission in the first reference signal set. And furthermore, the terminal equipment may assess the radio link quality in the second cell according to the reference signal related to the downlink control channel in the second reference signal set. Hence, when a beam failure occurs, the terminal equipment may still assess the radio link quality, and the communication system may quickly adjust and recover transmission of downlink signals.

### Embodiment 9

The embodiment of this disclosure provides a network device, including the apparatus described in Embodiment 7.

FIG. 12 is a schematic diagram of one implementation of the network device of the embodiment of this disclosure. As shown in FIG. 12, a network device 1200 may include a central processing unit (CPU) 1201 and a memory 1202, the memory 1202 being coupled to the central processing unit 1201. The memory 1202 may store various data, and furthermore, it may store a program for data processing, and execute the program under control of the central processing unit 1201, so as to receive various information transmitted by a terminal equipment, and transmit various information to the terminal equipment.

In one implementation, the functions of the apparatus described in Embodiment 7 may be integrated into the central processing unit 1201, and the central processing unit 1201 executes functions of the apparatus described in described in Embodiment 7. The functions of the apparatus described in Embodiment 7 are incorporated herein, and shall not be described herein any further.

In another implementation, the apparatus described in Embodiment 7 and the central processing unit 1201 may be configured separately; for example, the apparatus described in Embodiment 7 may be configured as a chip connected to the central processing unit 1201, and the functions of the apparatus described in Embodiment 7 are executed under control of the central processing unit 1201.

Furthermore, as shown in FIG. 12, the network device 1200 may include a transceiver 1203, and an antenna 1204, etc. Functions of the above components are similar to those in the related art, and shall not be described herein any further. It should be noted that the network device 1200 does not necessarily include all the parts shown in FIG. 12. Furthermore, the network device 1200 may include parts not shown in FIG. 12, and the related art may be referred to.

With the network device of this embodiment, the terminal equipment may assess the radio link quality in the first cell according to the reference signal related to the downlink data transmission in the first reference signal set. And furthermore, the terminal equipment may assess the radio link quality in the second cell according to the reference signal related to the downlink control channel in the second reference signal set. Hence, when a beam failure occurs, the terminal equipment may still assess the radio link quality, and the communication system may quickly adjust and recover transmission of downlink signals.

### Embodiment 10

The embodiment of this disclosure provides a communication system, including a network device and a terminal equipment. The network device is, for example, the network device 1200 described in Embodiment 9, and the terminal equipment is, for example, the terminal equipment 1100 described in Embodiment 8.

In this embodiment, the terminal equipment is, for example, a UE served by a gNB, and may include conventional compositions and functions of a terminal equipment in addition to the functions of the apparatus described in Embodiment 3 or 4 or 5, which are as described in Embodiment 8, and shall not be described herein any further.

In this embodiment, the network device may be, for example, a gNB in NR, and may include conventional compositions and functions of a network device in addition to the functions of the apparatus described in Embodiment 6, which are as described in Embodiment 9, and shall not be described herein any further.

With the communication system of this embodiment, the terminal equipment may assess the radio link quality in the first cell according to the reference signal related to the downlink data transmission in the first reference signal set. And furthermore, the terminal equipment may assess the radio link quality in the second cell according to the reference signal related to the downlink control channel in the second reference signal set. Hence, when a beam failure occurs, the terminal equipment may still assess the radio link quality, and the communication system may quickly adjust and recover transmission of downlink signals.

An embodiment of this disclosure provides a computer readable program, which, when executed in a terminal equipment, will cause a computer to carry out the method described in Embodiment 1 or 2 in the terminal equipment.

An embodiment of this disclosure provides a storage medium, including a computer readable program, which will cause a computer to carry out the method described in Embodiment 1 or 2 in a terminal equipment.

An embodiment of this disclosure provides a computer readable program, which, when executed in a network device, will cause a computer to carry out the method described in Embodiment 3 in the network device.

An embodiment of this disclosure provides a storage medium, including a computer readable program, which will cause a computer to carry out the method described in Embodiment 3 in a network device.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules.

Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

As to implementations containing the above embodiments, following supplements are further disclosed.

1. An apparatus for assessing radio link quality, configured in a terminal equipment, the apparatus including:

a first assessing unit configured to assess radio link quality in a first cell according to a reference signal related to downlink data transmission in a first reference signal set.

2. The apparatus according to supplement 1, wherein the first cell is a cell not configured with a downlink control channel, or a cell scheduled by control signals of other cells than the first cell.

3. The apparatus according to supplement 1 or 2, wherein,

the first reference signal set is a set of reference signals provided by a higher layer parameter and for the purpose of beam failure detection, or

the first reference signal set is a set of reference signals quasi co-located (QCL) with reference signals associated with downlink data transmission in a set of reference signals provided by a higher layer parameter and for the purpose of beam failure detection, or a set of reference signals with the same indices as reference signals associated with downlink data transmission in a set of reference signals provided by a higher layer parameter and for the purpose of beam failure detection.

4. The apparatus according to supplement 3, wherein the terminal equipment is provided with the higher layer parameter indicating reference signals for the purpose of beam failure detection.

5. The apparatus according to supplement 1 or 2, wherein the first reference signal set is a set of reference signals quasi co-located (QCL) with reference signals associated with downlink data transmission, or a set of reference signals with the same indices as reference signals associated with downlink data transmission.

6. The apparatus according to supplement 5, wherein the terminal equipment is not provided with the higher layer parameter indicating reference signals for the purpose of beam failure detection.

7. The apparatus according to any one of supplements 1-6, wherein the reference signals associated with downlink data transmission are:

reference signals to which TCI states in a TC state list configured by a higher layer parameter correspond, or

reference signals to which TCI states indicated by higher layer signaling correspond, or

if the terminal equipment receives higher layer signaling, the reference signals associated with downlink data transmission are: reference signals to which TCI states indicated by the higher layer signaling correspond, and if the terminal equipment does not receive higher layer signaling, the reference signals associated with downlink data transmission are: reference signals to which TCI states in a TCI state list configured by a higher layer parameter correspond, or

if the terminal equipment receives higher layer signaling, the reference signals associated with downlink data transmission are: reference signals to which TCI states indicated by the higher layer signaling correspond.

8. The apparatus according to supplement 7, wherein the TCI states indicated by the higher layer signaling refer to:

TCI states mapped onto codepoints of a transmission configuration indication field of downlink control information (DCI) by the higher layer signaling.

9. The apparatus according to any one of supplement 1-8, wherein the reference signals are periodic channel state information reference signals (CSI-RSs) or synchronization signals/physical broadcast channels (SSs/PBCHs).

10. The apparatus according to supplement 1 or 2, wherein the first assessing unit assesses radio link quality according to comparison of measurement results of the reference signals with a threshold.

11. The apparatus according to supplement 10, wherein the threshold is a threshold related to a first parameter and a second parameter; wherein, the first parameter is a block error rate (BLER) for generating out-of-synchronization indication, and the second parameter is reference signal received power (RSRP) of SSs/PBCHs.

12. The apparatus according to supplement 10, wherein the threshold is a threshold used for being compared with a measurement result of RSRP of L1 layer of the reference signals.

13. The apparatus according to supplement 12, wherein the measurement result of RSRP of L1 layer of the reference signals is:

a measurement result of RSRP of L1 layer of the SSs/PBCHs; or

a measurement result of RSRP of L1 layer of CSI-RSs scaled by a higher layer parameter.

14. The apparatus according to supplement 1, wherein the apparatus further includes:

a second assessing unit configured to assess radio link quality in a second cell according to a reference signal related to a downlink control channel in a second reference signal set.

15. The apparatus according to supplement 14, wherein the second cell is a cell configured with a downlink control channel, or a cell scheduled by a control signal of the own cell.

16. The apparatus according to supplement 14 or 15, wherein the second reference signal set is a set of reference signals provided by a higher layer parameter and for the purpose of beam failure detection.

17. The apparatus according to supplement 14 or 15, wherein the second reference signal set is a set of reference signals quasi co-located (QCL) with reference signals associated with downlink control channel in a set of reference signals provided by a higher layer parameter and for the purpose of beam failure detection, or a set of reference signals with the same indices as reference signals associated with downlink control channel in a set of reference signals provided by a higher layer parameter and for the purpose of beam failure detection.

18. The apparatus according to supplement 16 or 17, wherein the terminal equipment is provided with the higher layer parameter indicating reference signals for the purpose of beam failure detection.

19. The apparatus according to supplement 14 or 15, wherein the second reference signal set is a set of reference signals quasi co-located (QCL) with reference signals associated with downlink control channel, or a set of reference signals with the same indices as reference signals associated with downlink control channel.

20. The apparatus according to supplement 19, wherein the terminal equipment is not provided with the higher layer parameter indicating reference signals for the purpose of beam failure detection.

21. The apparatus according to any one of supplements 14-20, wherein the reference signals associated with downlink control channel are:

DM-RSs used by the terminal equipment in monitoring a control channel, or

reference signals indicated by TCI states to which CORESET used by the terminal equipment in monitoring a control channel corresponds.

22. The apparatus according to any one of supplements 14-21, wherein the reference signals are periodic channel state information reference signals (CSI-RSs) or synchronization signals/physical broadcast channels (SSs/PBCHs).

23. The apparatus according to supplement 14 or 15, wherein the second assessing unit assesses radio link quality according to comparison of measurement results of the reference signals with a threshold.

24. The apparatus according to supplement 23, wherein the threshold is a threshold related to a first parameter and a second parameter; wherein, the first parameter is a block error rate (BLER) for generating out-of-synchronization indication, and the second parameter is reference signal received power (RSRP) of SSs/PBCHs.

25. The apparatus according to supplement 23, wherein the threshold is a threshold used for being compared with a measurement result of RSRP of L1 layer of the reference signals.

26. The apparatus according to supplement 25, wherein the measurement result of RSRP of L1 layer of the reference signals is:

a measurement result of RSRP of L1 layer of the SSs/PBCHs; or

a measurement result of RSRP of L1 layer of CSI-RSs scaled by a higher layer parameter. 27. A parameter configuration apparatus, configured in a network device, the apparatus including:

a first configuring unit configured to configure a first reference signal set for a terminal equipment, the terminal equipment assessing radio link quality in a first cell according to a reference signal related to downlink data transmission in the first reference signal set, the first cell being a cell not configured with a downlink control channel, or a cell scheduled by control signals of other cells than the first cell.

28. The apparatus according to supplement 27, wherein the apparatus further includes:

a first transmitting unit configured to transmit corresponding reference signals to the terminal equipment according to configuration information of the first reference signal set.

29. The apparatus according to supplement 27 or 28, wherein the apparatus further includes:

a second configuring unit configured to configure a second reference signal set for the terminal equipment, the terminal equipment assessing radio link quality in a second cell according to a reference signal related to a downlink control channel in the second reference signal set, the second cell being a cell configured with a downlink control channel, or a cell scheduled by a control signal of the own cell.

30. The apparatus according to supplement 29, wherein the apparatus further includes:

a second transmitting unit configured to transmit corresponding reference signals to the terminal equipment according to configuration information of the second reference signal set.

31. The apparatus according to any one of supplements 27-30, wherein the reference signals are reference signals for the purpose of beam failure detection.

What is claimed is:

1. An apparatus for assessing radio link quality, configured in a terminal equipment, the apparatus comprising:
processor circuitry configured to assess radio link quality in a first cell according to a reference signal related to downlink data transmission in a first reference signal set; and
memory.

2. The apparatus according to claim 1, wherein the first cell is a cell not configured with a downlink control channel, or a cell scheduled by control signals of other cells than the first cell.

3. The apparatus according to claim 1, wherein,
the first reference signal set is a set of reference signals provided by a higher layer parameter and for the purpose of beam failure detection, or
the first reference signal set is a set of reference signals quasi co-located (QCL) with reference signals associated with downlink data transmission in a set of reference signals provided by a higher layer parameter and for the purpose of beam failure detection, or a set of reference signals with the same indices as reference signals associated with downlink data transmission in a set of reference signals provided by a higher layer parameter and for the purpose of beam failure detection.

4. The apparatus according to claim 3, wherein the terminal equipment is provided with the higher layer parameter indicating reference signals for the purpose of beam failure detection.

5. The apparatus according to claim 1, wherein the first reference signal set is a set (q) of reference signals quasi co-located (QCL) with reference signals associated with downlink data transmission, or a set (q) of reference signals with the same indices as reference signals associated with downlink data transmission.

6. The apparatus according to claim 5, wherein the terminal equipment is not provided with the higher layer parameter indicating reference signals for the purpose of beam failure detection.

7. The apparatus according to claim 1, wherein the reference signals associated with downlink data transmission are:
reference signals to which transmission configuration indication (TCI) states in a TCI state list configured by a higher layer parameter correspond, or
reference signals to which TCI states indicated by higher layer signaling correspond, or
if the terminal equipment receives higher layer signaling, the reference signals associated with downlink data transmission are: reference signals to which TCI states indicated by the higher layer signaling correspond, and if the terminal equipment does not receive higher layer signaling, the reference signals associated with downlink data transmission are: reference signals to which TCI states in a TCI state list configured by a higher layer parameter correspond, or
if the terminal equipment receives higher layer signaling, the reference signals associated with downlink data transmission are: reference signals to which TCI states indicated by the higher layer signaling correspond.

8. The apparatus according to claim 7, wherein the TCI states indicated by the higher layer signaling refer to:
TCI states mapped onto codepoints of a transmission configuration indication field of downlink control information (DCI) by the higher layer signaling.

9. The apparatus according to claim 7, wherein the reference signals are periodic channel state information reference signals (CSI-RSs) or synchronization signals/physical broadcast channels (SSs/PBCHs).

10. The apparatus according to claim 1, wherein the processor circuitry assesses radio link quality according to comparison of measurement results of the reference signals with a threshold.

11. The apparatus according to claim 10, wherein the threshold is a threshold related to a first parameter and a second parameter; wherein the first parameter is a block error rate (BLER) for generating out-of-synchronization indication, and the second parameter is reference signal received power (RSRP) of SSs/PBCHs.

12. The apparatus according to claim 10, wherein the threshold is a threshold used for being compared with a measurement result of RSRP of L1 layer of the reference signals.

13. The apparatus according to claim 12, wherein the measurement result of RSRP of L1 layer of the reference signals is:
a measurement result of RSRP of L1 layer of the SSs/PBCHs; or
a measurement result of RSRP of L1 layer of CSI-RSs scaled by a higher layer parameter.

14. The apparatus according to claim 1, wherein the apparatus further comprises:
processor circuitry further configured to assess radio link quality in a second cell according to a reference signal related to a downlink control channel in a second reference signal set, the second cell being a cell configured with a downlink control channel, or a cell scheduled by a control signal of the own cell.

15. A parameter configuration apparatus, configured in a network device, the apparatus comprising:
processor circuitry configured to configure a first reference signal set for a terminal equipment, the terminal equipment assessing radio link quality in a first cell according to a reference signal related to downlink data transmission in the first reference signal set, the first cell being a cell not configured with a downlink control channel, or a cell scheduled by control signals of other cells than the first cell; and
memory.

16. The apparatus according to claim 15, wherein the apparatus further comprises:
a first transmitting unit configured to transmit a corresponding reference signal to the terminal equipment according to configuration information of the first reference signal set.

17. The apparatus according to claim 15, wherein the apparatus further comprises:
the processor circuitry further configured to configure a second reference signal set for the terminal equipment, the terminal equipment assessing radio link quality in a second cell according to a reference signal related to a downlink control channel in the second reference signal set, the second cell being a cell configured with a downlink control channel, or a cell scheduled by a control signal of the own cell.

18. The apparatus according to claim 17, wherein the apparatus further comprises:
a second transmitting unit configured to transmit corresponding reference signals to the terminal equipment according to configuration information of the second reference signal set.

19. The apparatus according to claim 15, wherein the reference signals are reference signals for the purpose of beam failure detection.

20. A communication system, comprising a network device and a terminal equipment; wherein,
the network device configures a first reference signal set for the terminal equipment;
and the terminal equipment assesses radio link quality in a first cell according to a reference signal related to downlink data transmission in the first reference signal set, the first cell being a cell not configured with a downlink control channel, or a cell scheduled by control signals of other cells than the first cell.
